(19) United States
(12) Patent Application Publication
(10) Pub. No.: US 2004/0127211 A1
(43) Pub. Date: Jul. 1, 2004

(54) Method for the production, by a service provider, of a multimedia isolating identifier

(76) Inventor: Jean-Philippe Wary, Bourg La Reine (FR)

Correspondence Address: PERMAN & GREEN, LLP, 425 Post Road, Fairfield, CT, 06824, US

(21) Appl. No.: 10/668,543

(22) Filed: Sep. 23, 2003

(30) Foreign Application Priority Data
Sep. 24, 2002 (FR) 0211803

(51) Int. Cl. H04M 3/42; H04M 7/00

(52) U.S. Cl. 455/422.1; 379/201.07; 379/219

(57) ABSTRACT

To protect the privacy of a user subscribing to a mobile telephony operator, the operator produces an isolating identifier by which the user can link up anonymously with a content provider. The operator/producer is the only entity capable of relating the isolating identifier to the user on request. An isolating identifier is, furthermore, either an isolating session identifier, hence one that changes at each connection of a user to a provider, or an isolating context identifier, hence one that persists over several connections. Furthermore, a context identifier is proper to a user/provider pair. This even further isolates the user. The format of the isolating identifier is compatible with the format of the NDS field, defined in the telephony standards.

### BACKGROUND OF THE INVENTION

### 1. Field of the Invention

An object of the invention is a method for the production of a multimedia isolating identifier by a service provider. The field of the invention is that a user's access to a content provider through a service provider. In particular, the field of the invention is that of the gateways existing between telephone networks and Internet, voice or SMS networks, or other carriers for the transmission of multimedia or monomedia contents.

It is an aim of the invention to preserve the user's privacy.

It is another aim of the invention to preserve the customer database of the actors of a network, and to restrict activities of behavior analysis.

It is another aim of the invention to contribute to preserving the secrecy of mail or correspondence.

It is another aim of the invention to enable an authorized legal entity to identify the civil status of a user.

It is another aim of the invention to enable the content provider to manage one or more contexts for users getting connected to said content provider.

It is another aim of the invention to remain compatible with the greatest number of networks.

### BRIEF DESCRIPTION OF RELATED DEVELOPMENTS

In the prior art, there are several means by which the content provider can identify a user who accesses one of his services. These means depend on the medium used by the user to access the service. Mainly four modes of access can be distinguished, but the list is not exhaustive. A first mode of access is that of Internet-type access. The Internet access mode can itself be divided into two sub-modes which may be called the connected mode and the unconnected mode. The connected Internet mode is a connection mode using an HTTP (Hyper Text Transfer Protocol) or WTP (Wireless Transfer Protocol) type of protocol. A server, for example a HTTP server, is an apparatus communicating with a network, for example the Internet, according to the HTTP protocol. Such a server hosts Web (Internet) or WAP (Wireless Application Protocol) type networks. There is also an unconnected Internet access mode using an SMTP (Simple Mail Transfer Protocol) type protocol in which the connection actually consists of an exchange of mail-type electronic messages.

Another access mode is a mode of access by operator. This mode itself is also subdivided into two sub-modes. A first access sub-mode, which constitutes a third access mode, is then an access mode that may be called an unconnected mode. This mode uses an SMS (Short Message Service) or MMS (Multimedia Message Service) type protocol. A fourth access mode is a connected mode of access by operator also known as a voice mode in which the accessing user links up with a voice server.

All four access modes have a simple type of solution which consists in making an interface that proposes the keying in of an identifier and a password during a connection to a server. Inasmuch as the user linking up with the server of the content provider does so through a mobile telephone, the means made available to the user in order to key in his identifier (or login username) and password are limited by the user interface of the telephone. Either the identifier and the password are totally numerical, in which case they are difficult to memorize and easy to guess, or the identifier and the password are alphanumerical, in which case it is a tedious task to enter them with a keypad having only nine keys. Furthermore, this keying-in step is an additional step for the user and, in most cases, discourages a mobile telephone user from linking up with a site that offers a connection interface of the type using an identifier and password.

Another approach, in the case of servers of the first type, consists in using a cookie. A cookie is a small file recorded in the user's machine. During a connection to a content provider, this content provider can access this cookie to identify the user. One problem with this approach lies in the fact that it is possible to steal a cookie by electronic or other means. The use of a cookie is therefore not compatible with high security requirements. Another problem then lies in the fact that cookies have a relatively poor reputation. This incites users to erase them. Furthermore, the user may configure the application, or navigator, that he uses to link up with the content provider, so that this application does not accept cookies. In this case, the user is unable to link up with the server of the content provider.

For the third and fourth access modes, the content provider most usually has access to the telephone number of the person calling the server. The content provider is therefore capable of identifying the person through this telephone number. This is bound to raise a problem of protection of privacy. Indeed, it is quite legitimate for the user that he should wish not to be physically identified when he or she links up with the server of the content provider. Indeed, it should be possible to acquire an article anonymously. It is possible, in this situation, to try and link up by masking one's number. However, in this case, it is impossible for the service to be invoiced and hence for the connection to be made effectively. At present, the only solution consists in not linking up with this content provider.

Furthermore, the solutions envisaged in the prior art do not all resolve the problem of the format of the data. Indeed, the transmission characteristics are not the same from one network to another, and therefore from one protocol to another. These characteristics relate mainly to the encoding of the information transmitted (digital, alphanumerical and other information) as well as the quantity of information that can be transmitted. Thus, an identifier that can be used on the Internet is not necessarily usable on a voice and/or SMS network.

In the description, and in practice, getting connected to or accessing a content provider is equivalent to getting connected to a server of a content provider.

The invention resolves these problems by enabling the production of an identifier that the user presents to the content provider, whatever the type of network, this identifier enabling no one, other than the entity having produced this identifier, to identify the civil status of the user. Such an identifier makes it possible to protect the user's privacy and enables the user to be properly identified through a request produced by the authority seeking to identify the user and comprising the identifier as well as the date on which this identifier is produced.

An identifier according to the invention comprises at least one first user identifier field. Other fields may ensure the variability of the identifier, and/or the qualification of the identifier. This variability is ensured either by a random variable, or by a stated desire of the user. The qualification of the identifier consists of information used to give interpretation clues relating to the nature of the identifier. Such clues are, for example, the operator that has produced the identifier, the lifetime of the identifier etc. The first field is encrypted so that this first field is accessible to no one. Only the service provider, namely the entity producing the isolating identifier is capable of inverting the encryption and therefore of physically identifying the user.

All the fields of the identifier according to the invention, including the encrypted fields, are in a format compatible with the most constraint-bound of the networks in which the identifier has to be conveyed. In practice, this condition pertains to the telephony network and its constraints for defining an identifier. The telephony network indeed imposes a maximum length and a digital encoding for the identifier.

The aims of the invention are therefore truly achieved.

### SUMMARY OF THE INVENTION

An object of the invention therefore is a method for the production, by a service provider (112), of a first multimedia user isolating identifier (118, 200) compatible with the identifiers (117) of a telephony network wherein:

the first identifier has a maximum size of 15 digits,

the first identifier has at least one productive digit making it possible to designate the producer of the identifier,

the first identifier has at least one nature-defining digit enabling the nature of the first identifier to be defined,

the first identifier has N identifying digits enabling the designation of the user,

the first identifier has M variability digits depending on the nature-defining digit.

### BRIEF DESCRIPTION OF THE DRAWINGS

The invention shall be understood more clearly from the following description and the accompanying figures. These figures are given purely by way of an indication and in no way restrict the scope of the invention. Of these figures:

FIG. 1 illustrates means useful to the implementation of the method according to the invention;

FIG. 2 illustrates a possible structure for an isolating identifier according to the invention; and

FIG. 3 illustrates steps for the implementation of the method according to the invention.

### DETAILED DESCRIPTION OF THE PREFERRED EMBODIMENT(S)

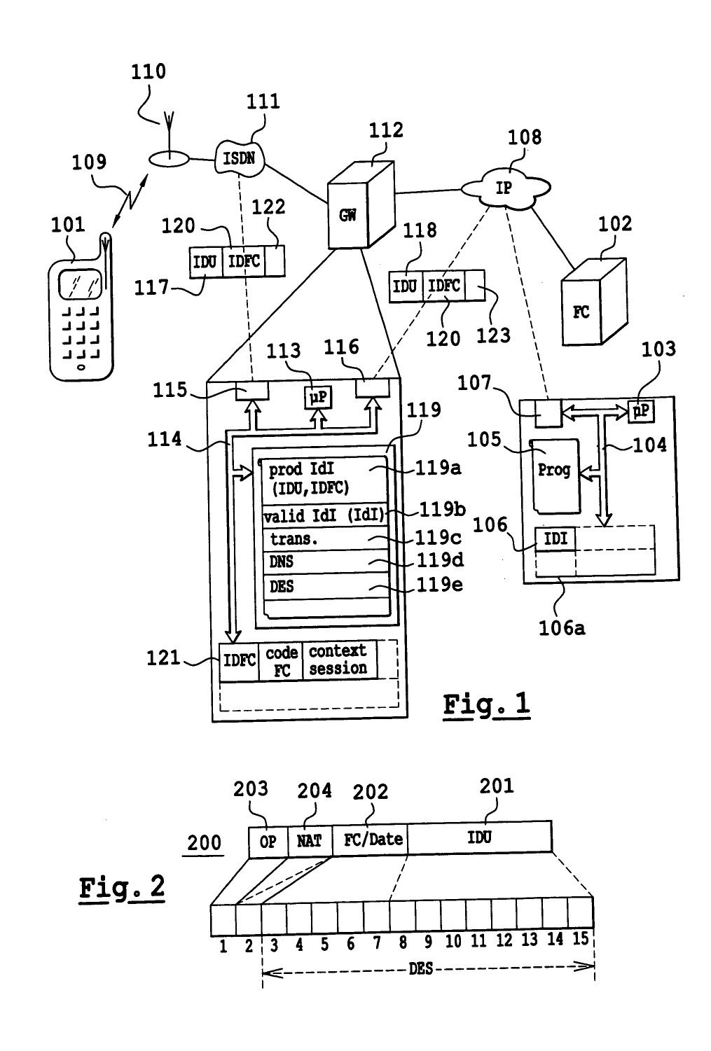

FIG. 1 shows an apparatus 101 used by a user to link up with a server 102 of a content provider. In practice, the apparatus 101 is a mobile telephone capable of setting up a connection according to several protocols. These protocols include Internet-compatible, voice-compatible and SMS-compatible protocols. In other words, the apparatus 101, which is a mobile telephone 101, is capable of setting up communication according to a WAP mode, voice mode and/or SMS mode.

The server 102 is capable of communicating according to at least one of the protocols referred to here above for the telephone 101. The server 102 has a microprocessor 103 connected to a bus 104 internal to this server 102. The bus 104 can be used to connect the microprocessor to a program memory 105, a user memory 106, and interface circuits 107 interfacing for example with the Internet 108.

The memory 105 has instruction codes which control the microprocessor when it performs different actions. In particular, the memory 105 has instruction codes for implementing at least one of the protocols referred to here above.

The memory 106 is, for example, a database. To this end, the memory 106 is described as a table comprising at least as many rows as there are users likely to link up with the server 102 or are already linked up with this server 102. Each row has certain number of fields. A column 106a corresponds to a user identifier field. This is an identifier according to the invention. When the server 102 receives a request, the request comprises this identifier. This enables the server 102 to identify the user and, for example, determine preferences of the user. A set of preferences is also called a context. A context comprises various pieces of information by which the user can customize the appearance and/or the contents of the information presented to him by the server to which he gets connected.

In the example, the memory 106 is included in the server 102. In practice this memory/database 106 may be hosted by another server to which the server 102 can get connected in order to access the contents of said database.

When a user uses the apparatus 101 to get connected to the server 102, the telephone 101 sets up an RF link 109 with the base station 110. The base station 110 is itself connected, through a network 111, for example an ISDN network to a gateway 112 of a service provider to which, for example, the user of the telephone 101 is a subscriber. The ISDN network 111 is actually all or part of a switched telephone network. In practice, the network 111 may constitute any technical solution whatsoever used to connect a base station to the gateway 112 of the service provider. A service provider is for example a mobile telephony operator.

The content provider is, for example, an access gateway to the Internet, also known as an Internet portal, a weather forecasting voice server or a standard SMS server.

The gateway 112 has a microprocessor 113, connected to a bus 114. This bus 114 also has the following circuits connected to it: interface circuits 115 for interfacing with the network 111 and circuits 116 for interfacing with the network 108. The gateway 112 is therefore a gateway between the networks 111 and 108.

On the network 111, the apparatus 101 and therefore its user are identified by a user identifier 117. On the network 108, the user of the apparatus 101 is identified, at least, by an isolating identifier 118. One role of the gateway 112 is to set up the link between the identifier 117 and the isolating identifier 118. Another classic role of the gateway 112 is that of carrying out a protocol conversion between the protocols used on the network 111, and the protocols used on the network 108. The identifier 117 is, for example, the phone number of the user of the apparatus 101. Such an identifier 117 is a public identifier that enables everybody to associate a physical person with it. One aim of the invention is to prevent the content provider from physically identifying the persons that get connected to the server 102.

The gateway 112 has a program memory. The memory 119 has different zones comprising instruction codes, each corresponding to a task performed by the microprocessor 113.

The zones of the memory 119 include a zone 119a comprising instruction codes corresponding to the production, by the gateway 112, namely in fact by the microprocessor 113, of the isolating identifier 118 from at least the identifier 117 and, in a preferred mode of implementation, the production of an identifier 120 of the content provider.

The zone 119b has instruction codes enabling the gateway 112 to validate an identifier 118 when the gateway 112 receives a request from the server 102. A zone 119c has instruction codes enabling the gateway 112 to identify a user from an isolating identifier 118. This is used to transmit a response from the server 102 to the apparatus 101 for example. A memory zone 119d has instruction codes used to determine an identifier modifier from an identifier 120 of the content provider. A zone 119e has instruction codes used to perform a transcoding operation which, in the present example, is an encryption operation. Preferably, this is a symmetrical encryption operation. However, it could be a simple permutation or scrambling operation.

The gateway 112 has a memory 121 used to associate an identifier of a content provider with a code for this content provider, and with a designation of a nature of an isolating identifier to be produced.

FIG. 2 illustrates a possible structure for an isolating identifier according to the invention and its adaptation to transmission from a telephony network through the NDS field defined in the telephony standards, especially in the voice telephony standard. The standard lays down a 15-digit encoding of the NDS field. A service provider does not need to use the entire space laid down by this standard to identify a subscriber. However, the network protocols always convey 15 digits for the NDS field, which can therefore be used to convey information identifying the user, as well as additional information.

FIG. 2 shows an isolating identifier 200 comprising four fields. A first field 201, with the length of N digits, corresponds to the identifier 117 identifying the user of the apparatus 101 on the network 111. A second field 202, with a length of M digits, corresponds to a means of making the isolating identifier 200 vary as a function either of a requirement of the user or a content provider code. The fields 202 and 201 are encrypted by means of instruction codes of the zone 119e.

In one variant, the isolating identifier 200 has a field 203 by which it is possible to identify the service provider that has produced the identifier, and a field 204 making it possible for example to encode a version, or nature, for the isolating identifier 200. The isolating identifier 200 is used as an isolating identifier 118 during communications between the gateway 112 and the server 10/2. It is the isolating identifier 118 that is recorded in the column 106a of the user memory 106 of the server 102.

FIG. 2 shows that the sum of the length of the fields of the identifier 200 does not exceed the length of the NDS field, namely 15 digits. A digit is a computer representation used to represent/encode a decimal figure. In practice, a digit comprises four bits, and only the encodings 0000, 0001, 0010, 0011, 0100, 0101, 0110, 0111, 1000, and 1001 are used. The general principle is that such a digit is capable of encoding 16 states. In general, only ten of these states are used. Any selection whatsoever of 10 states out of the 16 states is therefore suitable. FIG. 2 also illustrates lengths for the fields 201 to 204. These lengths of the fields of the identifier can be adapted to the situation. Thus, for example, if it is desired to have more than one digit for the field 203, the field 201 or 202 can be shortened. Similarly, the location of the fields is indicative. For example, the field 202, in the present example, occupies 3 to 7 digits; in practice, if M is equal to 5, it may occupy 5 digits out of the 15 digits of the NDS field. This is also true for the location of the fields 201, 203 and 204.

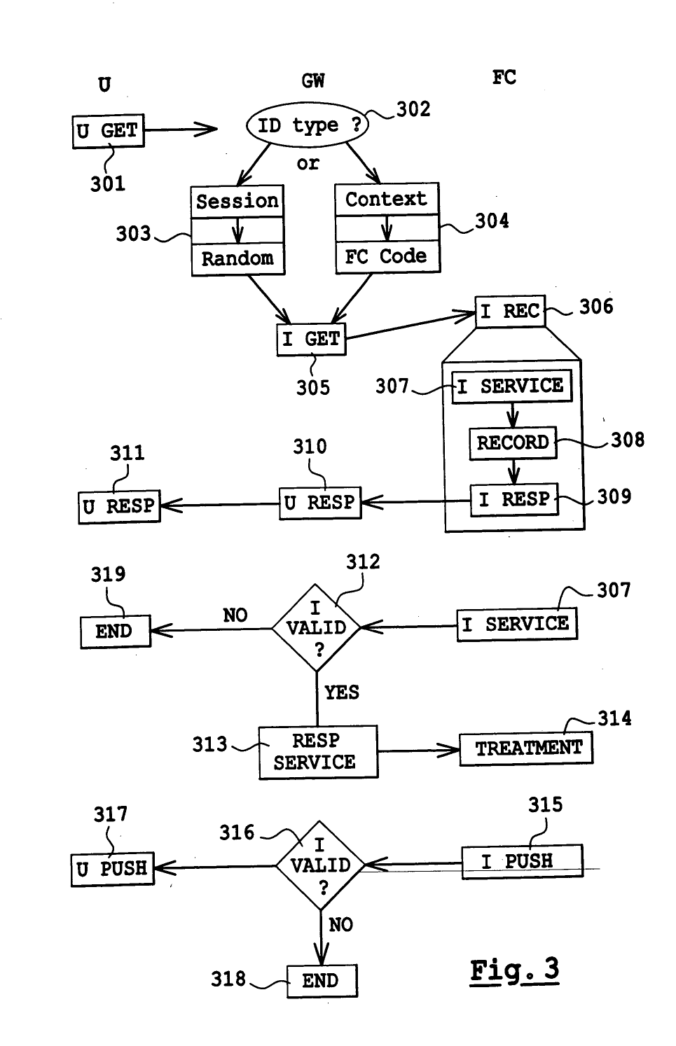

FIG. 3 shows the steps of a scenario in which the method according to the invention is implemented.

FIG. 3 shows a step 301 in which the telephone 101 sends out a request to the content provider 102. This request has a user identifier 117, a content provider identifier 120, and a field 122 comprising the request itself. Such a request is, for example, a “Get” request as defined under the HTTP protocol. It must be noted that, since the apparatus 101 is a mobile telephone, it is the WTP protocol that is used. The request produced and sent at the step 301 is received in a step 302 by the gateway 112. In the step 302, the microprocessor 113 extracts the content provider identifier 120 from the request. It then scans the table 121 in search of this content provider identifier. Once it has found the content provider identifier, the microprocessor 113 is capable of determining a code for this content provider as well as an identifier nature. If the identifier of the content provider does not appear in the table 121, then the microprocessor 113 adopts a default mode of behavior. In the present example, it is assumed that the default mode of behavior consists in producing an isolating session identifier.

The identifier 120, in a preferred example, is an address in the IPV4 (Internet Protocol Version 4) format. It may also be a telephone number of a voice server, or an SMS, or MMS identifier. It may also be an Internet address in the IPV6 (Internet Protocol Version 6) format or a URL (Universal Resource Locator).

If, in the table 121, the content provider identifier 120 corresponds to a nature of an isolating session identifier, the operation passes to a step 303 for the production of an isolating session identifier. If not, it passes to a step 304 for the production of the isolating context identifier.

Whether it is an isolating session identifier or an isolating context identifier, both have the same structure which is the one described for FIG. 2. What differentiates a session identifier from a context identifier is the contents of the field 202. In the case of the session identifier, the field 202 includes a random element. Such a random element is constituted, for example, by the number of seconds that have elapsed since 00.00 hours on Jan. 1^{st}, 1970. Such a random element may also be any number whatsoever generated by a pseudo-random number generator initialized by the time at which the random element was produced. The random element may also be the value of a counter incremented at each new production of an identifier. In general, the random element is a random or pseudo-random number.

In the case of a context identifier, the field 202 comprises for example a content provider identifier, or a date.

In the case of the dates, for the field 202, this is either a date for the creation of the isolating identifier, or a date of expiry of the validity of the isolating identifier. In one variant, it may happen that the session and isolating context identifiers are both formed from dates. In this case, a context identifier is distinguished by its duration of validity which is far greater than it is for a session identifier whose validity does not exceed a quarter of an hour.

In the step 304, the field 202 corresponds to the content provider code read in the memory 121 at the step 302. This content provider code is then preferably a digital code compatible with the digit format.

The field 204 can be used for example to encode the nature of the identifier. The field 204 therefore has one value when it is an isolating session identifier, and another value when it is an isolating context identifier. When the value of the field 202 is determined, the microprocessor 113 is capable of producing an isolating identifier according to the invention. The microprocessor 113 encrypts the set formed by the field 202 and the field 201. Then the microprocessor 113 associates the result of the encryption with an identifier 203 of the operator managing the gateway 102, and with the nature 204 of the isolating identifier. Thus, the isolating identifier 118 is obtained. It can be seen that the size of the isolating identifier may be different from the size of the identifier 117.

Once the isolating identifier 118 has been produced, the operation passes to a step 305 for the production and sending of a request to the server 102. The request produced in the step 305 comprises an isolating identifier 118, a content provider identifier 120 and a request field 123. In practice, the fields 120 and 123 are identical to the fields 120 and 122. In the present example, the request produced in the step 305 is in the HTTP format. In this case, the field 120 is then a destination IP address. In practice, the request produced in the step 305 by the gateway 112 is in a format (voice, SMS, IP etc) compatible with the server that the user of the telephone 101 is seeking to link up with.

The isolating identifier field 118 is a field in the format described for FIG. 2. The isolating identifier 118 then comprises a field identifying the operator that has produced the isolating identifier, a field to encode the nature of the isolating identifier depending on whether it is a session identifier or a context identifier, and an encrypted field. The encrypted field, when deciphered, comprises two fields. These two fields correspond to the fields 202 and 201.

In the invention, there is an additional constraint linked to the format of the NDS field. The field 118 must be compatible with the NDS format. This means that the field 118 has a 15-digit length, and that the fields 201 to 204 are included in the 15 digits.

Whatever the case in question, it is considered that the field 201 enables the identification of a subscriber of the service provider. Classically, the field 201 will comprise the significant digits of a phone number, namely eight digits in France and five digits or more in other countries. In the case of France, the field 201 is therefore recorded by using the identifier digits which, in the present example, are the digits 8 to 15. This represents eight digits; in practice it could be any group of eight among the 0.15 digits. There are therefore seven digits remaining for the fields 202 to 204.

The first digit among the seven remaining digits, preferably the digit number 1, is deemed to enable the encoding of the entity that has produced the isolating identifier 200. This enables the encoding of ten operator-type entities when NDS field format standards are complied with, and 15 operator-type entities when these standards are not complied with. The digit is also called a producer digit; it corresponds to the fields 203.

In a preferred embodiment, a second digit of the seven remaining digits, for example the digit number 2, is used to encode the nature of the identifier, depending on whether it is a session identifier or a context identifier. It is then also called a nature digit; it corresponds to the field 204 and is optional.

In one variant the remaining digits, in the present example the digits numbered 2 to 7, serve to encode a date, for example in the month, date and time format, with each piece of information taking up two digits. It is noted that in this variant, the digit number 2 encodes two pieces of information, one pertaining to nature and one to date. In this specific case, it is assumed that a value of 0 or 1 for the digit number 2 corresponds to a session identifier, the digits numbered 2 to 7 being interpretable as a date. If the digit number 2 is equal to 3, then the digits numbered 3 to 7 are a content provider code, and there is then a context identifier. If the digit numbered 2 is equal to a figure from 4 to 9, then it is reserved for subsequent use.

There are other possible formats for encoding a date. For example, the date can be measured in fractions of a year from the beginning of a current year. If we consider fractions of 1/900000^{th} of a year, the value of 0 to 8 for the digit number 2 means that the digits numbered 2 to 7 encode a date, and that the identifier is a temporary identifier or a session identifier. If we consider fractions of 1/800000^{th} of a year, the value of 0 to 7 for the digit number 2 signifies that the digits numbered 2 to 7 encode a date and that the identifier is a temporary identifier or session identifier.

When the digit number 2 indicates that the identifier is a context identifier, then the digits numbered 3 to 7 enable the encoding of a content provider. In this case, one digit among the digits 3 to 7 can also be used to encode a version of a contract whereby the owner of the telephone number being used is bound to produce the isolating identifier to the operator producing the isolating identifier. Such a contract number is useful, for example, if the owner of the number changes or if the owner of the number wishes to keep his number, but wishes to erase every trace of his visits to content providers.

In practice, the information on producer and nature are not encrypted. The other information, corresponding in the present example to the digits 3 to 15, is encrypted. The encryption algorithm takes up one 13-digit word, and produces one 13-digit word. Thus, the isolating identifier 200 produced remains compatible with the standards laying down the use of digits. The size of the words consumed/produced varies with the size of the information to be encrypted.

The NDS format identifier thus produced is compatible with all the present-day transmission protocols.

After having sent the request, at the step 305, the operation passes to a step 306 for the reception of the request sent in the step 305 by the server 102. In the step 306, the server 102 therefore has access to the fields 118 and 123. The field 118 enables it to consult the table 106 in search of certain pieces of information on the user who is linking up with the server 102. In practice, if it is an isolating session identifier, there is little likelihood that the table 106 will comprise information on the user. Indeed, since a session identifier varies at each session, the same user will not link up twice with the server 102 using the same isolating session identifier. For this description, the term “session” is understood to mean a period of time limited, for example, to a quarter of an hour. The duration of the session can easily be measured because an isolating session identifier according to the invention comprises a piece of information on the date of creation.

A context identifier may have a far greater lifetime, for example six to eighteen months, or even more. The lifetime of a context identifier is managed, for example, by the key used to carry out the encryption which changes at the frequency of the lifetime of a context identifier. The lifetime of a context identifier may also be managed by the contents of the field 202 which change at the frequency of the lifetime of the context identifier.

The choice of the lifetime duration, and of its mode of management, is up to the entity responsible for the gateway 112. The fact that the lifetime is guaranteed enables a content provider to associate information, also called context, with this isolating identifier.

Among the possible actions at the step 306, the server 102 may produce and send out a service request to the gateway 112 from the identifier 118. This is the step 307. The server may record information in the table 106, this is the step 308. The server may produce and send out a response to the request from the user of the telephone 101. This is the step 309.

When the server 102 produces a response to the request sent at the step 305, it sets up a response frame comprising a field 118 identifying a user, a field 120 comprising an identifier of the server making the response, and a field 123 which then comprises the response to the request. In a step 310, the gateway 112 receives the response to the request sent at the step 301. The gateway 112 then performs a transcoding between the identifiers 118 and 117 to transmit the response from the server 102 to the telephone 101. The operation then passes to a step 311 in which the apparatus 101 receives the response to the request that it has sent in the step 301.

In the step 310, the transcoding of an identifier can be accompanied by a verification of the validity of the identifier. This verification is done, for example, after the encryption of the encrypted part of the isolating identifier 118 and thus the retrieval of the value of the field 202. The validation then depends on the nature of the identifier. If it is a session identifier, the field 202 corresponds to a date. This date is then compared with the date at which the response was received. If the difference between these two dates is greater than a predefined period, for example a quarter of an hour, then the request is considered to be non-valid and will not be retransmitted to the apparatus 101.

If it is a context identifier, then the contents of the field 202 are compared with the contents of the code field in the table 121 for the row corresponding to the identifier 120. If there is a match, the request is valid; if not the request is rejected.

In the step 307 the server 102 sends out a service request to the server 112. This request comprises a user isolating identifier, a content provider identifier, and a request field. Such a request may relate, for example, to a user identification request, a request for locating a user, or request for information on the nature of the apparatus used by the user to get connected to the server 102. This list is not exhaustive. At the step 312, the server 112 receives the service request. At the step 312, the gateway 112 starts by verifying the validity of the isolating identifier. This verification is done as described here above. If the identifier is not valid, the operation passes to an end step 319 in which the gateway 112 does not comply with the service request; if not, the operation passes to a step 314 of response to the service request.

In one variant of the invention, for each content provider, the table 121 furthermore comprises a list of services that the content provider can claim. In the step 313, the gateway 112 then verifies that the content provider sending the request is truly entitled to send this request, i.e. that it can claim this service. If this is the case, the gateway 112 produces a response to this service request and transmits the response to the server 102. If not, there is no response to the service request.

In a step 314, the server 102 receives the response to the service request. This response enables a server 102 to update the table 106 or produce the response of the step 309. Indeed, it can be envisaged that the request sent at the step 301 was a request to know the list of restaurants close to the place in which the user is located. In this case, the server 102 needs to know the location of the user. The server 102 therefore sends a location request to the gateway 112. The response to this location enables a server 102 to send the appropriate response to the user of the apparatus 101.

Thanks to an identifier according to the invention, the server 102, in a step 315, can also send a push request to the apparatus 101. This push request is received in a step 316 by the gateway 112. This push request is subjected to verification by the identifier 118. This verification is identical to the verifications described for the steps 310 and 312 and 313. In other words, the content provider identified by the field 120 must be authorized to send out a push request and, furthermore, the identifier 118 should be valid. If the identifier is not valid, the operation passes to an end step 318 in which no positive response whatsoever is given to the push request sent out by the server 102.

If this step 316 reveals that the push request sent at the step 315 is valid, then the gateway 112 transcodes the isolating identifier 118 into an identifier 117 and transmits the transcoded push request to the telephone 101. In a step 317, the telephone 101 receives and processes this push request. Such a push request is, for example, an updating of a database in the apparatus 101. Such a database may relate, for example, to contacts that the user of the apparatus 101 wishes to keep, or a list of servers that the apparatus 101 can link up with in order to access different services.

The encryption algorithm used to encrypt the fields 202 and 201 is preferably an algorithm of the DES (Data Encryption System) family. It may be the block encryption version or the chained encryption version of this algorithm. The chained encryption version makes it possible to ensure that all the encrypted parts of the identifier 200 will be different owing to the variable field 202. Variants of the invention may use other encryption algorithms such as those of the AES (Advanced Encryption System) family.

One advantage of the invention and of the isolating context identifiers defined by it is that one user can have a different context identifier for each content provider. It is thus impossible for a content provider to collate his databases with the databases of other content providers so as to obtain more knowledge about the private lives of users identified by the identifier. It is also impossible to raid a database, or infringe the secrecy of communications. Thus, maximum protection is obtained for the user's privacy.

The legal requirements are also met since, starting from an identifier and only for the operator who has produced this identifier, it is possible to trace an operation back to the physical user.

A user may choose to link up always by using a session identifier. Thus, during two connections that are reasonably spaced out in time, the user who has made this choice will link up with a same site by presenting two different isolating identifiers. The content provider then has no means of determining that it is the same user who has linked up twice.

The user may choose to have recourse to a context identifier. In this case, the gateway 112 will produce an isolating context identifier during connections by the user who has made this choice. The content provider could then adapt its responses according to the information that it is capable of attaching to the isolating context identifier.

The user's choice is managed, on the gateway 112, through a table associating a user identifier, such as the identifier 117, with a choice of user.

The invention is totally transposable if we consider a user using a personal computer to link up with a content provider through an Internet service provider (or ISP). In this case, the connection mode between the personal computer and the gateway is a radiofrequency (GSM, UMTS etc.) mode, a cable (switched telephony network) mode, or other similar mode.

The invention also has the advantage of exempting the entity that manages the isolating identifiers from having to store these isolating identifiers. Indeed, since these identifiers are computed from data that is easily accessible at the time of computation, there is no need to store them.

What is claimed is:

1- A method for the production, by a service provider, of a first multimedia user isolating identifier compatible with the identifiers of a telephony network wherein:
the first identifier has a maximum size of 15 digits,
the first identifier has at least one productive digit making it possible to designate the producer of the identifier,
the first identifier has at least one nature-defining digit enabling the nature of the first identifier to be defined,
the first identifier has N identifying digits enabling the designation of the user,
the first identifier has M variability digits depending on the nature-defining digit.

2- A method according to claim 1, wherein a digit is a representation, in data processing, that enables the encoding of a decimal number.

3- A method according to claim 1, wherein a digit is a representation, in data processing, that enables the encoding of a hexadecimal number.

4- A method according to claim 1, wherein the identifier digits correspond to a telephone number of the user.

5- A method according to claim 4, wherein the identifier digits are preferably the digits 8 to 15, N being then equal to 8.

6- A method according to claim 1, wherein the producer digit is preferably the digit 1.

7- A method according to claim 1, wherein the nature-defining digit is preferably the digit numbered 2.

8- A method according to claim 1, wherein the M digits, preferably the digits numbered 2 to 7, enable the encoding of a date.

9- A method according to claim 1, wherein the M digits, preferably the digits numbered 2 to 7, enabling the encoding of a date in the month/day/time (mmddhh) format.

10- A method according to claim 9, wherein a value of 0 or 1 for the digit numbered 2 corresponds to a temporary identifier.

11- A method according to claim 1, wherein the M digits, preferably the digits numbered 2 to 7, represent the period of time that has elapsed since the beginning of the year in progress, expressed in 1/900 000^{th} fractions.

12- A method according to claim 11, wherein a value of 0, 1, 2, 3, 4, 5, 6, 7, or 8 for the digit numbered 2 corresponds to a temporary identifier.

13- A method according to claim 1, wherein the M digits, preferably the digits numbered 2 to 7, represent the period of time that has elapsed since the beginning of the year in progress, expressed in 1/800 000^{th} fractions.

14- A method according to claim 13, wherein a value of 0, 1, 2, 3, 4, 5, 6, or 7 for the digit numbered 2 corresponds to a temporary identifier.

15- A method according to claim 1, wherein the M variability digits enable the identification of a content provider.

16- A method according to claim 15, wherein M-1 digits among the M digits enable the content provider to be identified, while 1 digit among the M digits enables the identifying of a contract between the user and the service provider.

17- A method according to claim 1, wherein the identifier digits and the variability digits are encrypted.

18- A method according to claim 17, wherein the encryption algorithm is symmetrical and produces digits.
